(19) United States
(12) Patent Application Publication
(10) Pub. No.: US 2011/0102183 A1
(43) Pub. Date: May 5, 2011

(54) SPATIALLY RESOLVED TEMPERATURE MEASUREMENT INSIDE A SPATIAL DETECTION REGION

(75) Inventor: Georges A. Tenchio, Ebmatingen (CH)

(73) Assignee: SIEMENS AKTIENGESELLSCHAFT, Muenchen (DE)

(21) Appl. No.: 12/933,572

(22) PCT Filed: Mar. 20, 2008
(86) PCT No.: PCT/EP2008/053408

§ 371 Date: Dec. 3, 2010

(51) Int. Cl. G01K 3/00; G01K 7/16

(52) U.S. Cl. 340/577; 374/102; 340/584; 374/E03.001; 374/E07.018

(57) ABSTRACT

A device and a method enable a spatially resolved measurement of a temperature inside a spatially linear detection region. The device includes a measuring body having a first electric conductor, a second electric conductor, and an insulating material, which extends between the two electric conductors. The insulating material has a temperature-dependent specific electric resistance. The device further includes a measuring unit, which is connected to the first electric conductor and to the second electric conductor. The measuring unit has a transmitting unit and a receiving unit. The transmitting unit is equipped to apply a time-dependent electric input signal to the two electric conductors. The receiving unit is equipped to detect a time-dependent electric response signal of the measuring body to the input signal. Furthermore, an alarm system is described, which in addition to a central unit has at least one temperature measuring device of the type described above.

The present invention relates to the technical field of alarm technology. In particular, the present invention relates to a device and a method for the spatially resolved measurement of the temperature inside a spatially linear detection region. Furthermore, the present invention relates to an alarm system for detecting local temperature changes inside a spatially linear detection region which, in particular, is suitable for the spatially resolved detection of fire sources.

In the field of alarm technology, it is often necessary to detect the temperature inside a larger detection region. In principle, a plurality of discrete spatially distributed temperature measuring devices can be installed within the required detection region for this purpose. However, this requires high installation outlay.

So-called linear electronic heat detectors have therefore been developed in order to be able to detect the temperature inside an elongated detection region with reasonable technical outlay. These typically consist of a relatively thick cable into which addressable, discrete sensors are incorporated at freely selectable intervals. Heat detectors of this kind therefore represent a technological mixture of discrete fire alarm technology with a plurality of individual sensors and truly linear fire alarm technology. Each sensor can be interrogated by means of the addressing. If an individual sensor detects a dangerous temperature, this condition can be spontaneously transmitted with the appropriate address, which is linked to the spatial position of the sensor, to a central unit. However, particularly in the case of large distances, linear electronic heat detectors of this kind have the disadvantage that the distance between the individual sensors is relatively large due to the limited number of sensors. In addition, along with a high installation and maintenance outlay, the multiple connections of the individual sensors also lead to quality problems, which are characterized by a poor compatibility with respect to electromagnetic interference.

A heating cable, which has a conducting core with a coating of NTC material and a spirally wound heating wire, is disclosed in U.S. Pat. No. 7,180,037 B2. The conducting core is located within an insulating sheath. The heating cable can be coupled to a control unit. A phase shift of a measuring signal relative to an AC current signal is indicative of the temperature of the heating cable. The detection of hot spots along the entire length of the heating cable can be improved as a result of the non-linear character of the NTC coating.

The use of so-called pneumatic heat detectors for measuring the temperature inside an elongated detection region is also known. With these, a pressure change brought about by a local change in temperature is measured inside an elongated tube filled with a suitable gas. An alarm can be triggered using a pressure sensor. However, pneumatic heat detectors have the disadvantage that they are typically very insensitive, so that a locally limited temperature change which is small in comparison with the overall length of the tube is frequently not detected. Furthermore, when a temperature change is detected, a localization of the temperature change is not possible.

Furthermore, for a precise spatially resolved temperature measurement inside an elongated detection region, it is possible to use an optical glass fiber with which the phenomenon of temperature-dependent Raman scattering is evaluated. Compared with an injected primary light beam, optical Raman scattering has a small frequency shift which can be selectively evaluated. Spatial resolution with regard to the origin of the Raman scattering can be carried out with classical optical radar technology, so-called Optical Time Domain Reflectometry (OTDR). However, OTDR within optical glass fibers has the disadvantage that appropriate measuring systems require high installation outlay, as typically it is not possible to use the usual means of electrical installation in buildings. Furthermore, a highly stable laser is required to generate the primary light beam, and the sensors and evaluation electronics required for analyzing the optical Raman scattering signal are very expensive.

The object of the invention is to specify a device and a method which enable a spatially resolved measurement of the temperature inside a spatially linear detection region in a simple manner.

This object is achieved by the subject matter of the independent claims. Advantageous embodiments of the present invention are described in the dependent claims.

According to a first aspect of the invention, a device for the spatially resolved measurement of the temperature inside a spatial detection region is described. The device described has (a) a measuring body with a first electrical conductor, a second electrical conductor and an insulating material which extends between the two electrical conductors, wherein the insulating material has a temperature-dependent specific electrical resistance, and (b) a measuring unit which is connected to the first electrical conductor and to the second electrical conductor and which has a transmitting unit and a receiving unit. The transmitting unit is set up to apply a time-dependent electrical input signal to the two electrical conductors. The receiving unit is set up to detect a time-dependent electrical response signal of the measuring body to the input signal.

The temperature measuring device described is based on the knowledge that, in the event of a change in the temperature of the measuring body, the impedance of the measuring body changes at least locally due to the temperature-dependent electrical resistance of the insulating material. As a result, its impedance also changes, at least within a certain region of the measuring body, particularly for a high-frequency input signal. This change in impedance in turn leads to a specific reflection behavior of the measuring body. The appropriate reflections are detected by the receiving unit of the measuring unit and can be analyzed by an evaluation unit connected downstream of the receiving unit.

In principle, the insulating material can be any material which has an appropriately strong temperature dependence of its specific electrical conductivity. In an equivalent circuit, the insulating material is represented by an in principle infinite number of discrete individual resistors which are connected between the two electrical conductors. In this regard, it can be easily seen that a local temperature change at the appropriate point of the measuring body leads to a change in impedance which leads to an at least partial reflection of high-frequency input signals.

According to an exemplary embodiment of the invention, the measuring body additionally has (a) at least one further first electrical conductor, (b) at least one further second electrical conductor, and (c) at least one further insulating material which extends between the two further electrical conductors, wherein the further insulating material has a temperature-dependent specific electrical resistance.

The at least one further first electrical conductor and the at least one further second electrical conductor can likewise be connected to the measuring unit described above in such a way that the transmitting unit of the measuring unit is also able to apply a time-dependent electrical input signal to the at least two further electrical conductors. In a corresponding manner, the receiving unit of the measuring unit is then also able to receive a time-dependent electrical response signal of the two further electrical conductors to the input signal.

The measuring unit can also have a switching unit so that a pair of electrical conductors can in each case be individually coupled to the transmitting unit or to the receiving unit. In this way, a temperature measurement can in each case be carried out sequentially by means of a plurality of conductor pairs without having to deal with unwanted interference between different signal components of an input signal which is injected simultaneously into different conductor pairs.

Attention is drawn to the fact that the temperature measuring device described can also have a plurality of measuring units each with a transmitting unit and a receiving unit. In this case, a temperature measurement can be carried out simultaneously and without mutual interference between different conductor pairs.

The insulating material and the further insulating material can be the same material. The temperature measuring device described can therefore have a common insulating material. The different electrical conductors can in each case be accommodated in pairs in any spatial arrangement in this common insulating material. This means that the different conductor pairs can be arranged spatially in any way within the measuring body. For example, the conductor pairs can be cast into the insulating material in a suitable manner.

The different conductor pairs can, for example, be arranged within a flat or curved surface. A close-meshed two-dimensional covering can be realized, for example, by a meandering arrangement of the conductor pairs within the plane or curved surface. By this means, the temperature can be measured with a high spatial resolution, not only along a single conductor pair inside a linear detection region, but also inside a two-dimensional detection region. In this way, for example, the wing of an aircraft can be monitored in two dimensions for local temperature changes.

The different conductor pairs can also be laid in a three-dimensional arrangement inside the measuring body. This enables the spatially resolved detection of local temperature changes inside a three-dimensional detection region.

Attention is drawn to the fact that, for accurate spatial resolution when measuring temperature, the exact spatial position of the different conductor pairs within the measuring body should be known as accurately as possible. In particular, the spatial arrangement of the conductor pairs should not change with time. This also applies with regard to adverse environmental conditions such as, for example, the presence of chemically aggressive substances, exposure to extreme temperatures and/or temperature variations, or under other environmental conditions which are stressful for the material.

According to a further exemplary embodiment of the invention, the device additionally has a termination resistor which is connected to the electrical conductors at an end of the electrical conductors which is opposite to the measuring unit.

The termination resistor preferably has a resistance which corresponds to the wave resistance of the cable under normal temperature conditions. In this context, the term normal conditions means the temperatures which are usually present in the detection region. Under normal temperature conditions, the whole measuring body therefore constitutes a measuring system with a uniform impedance so that no reflections whatsoever or only very weak reflections of a high-frequency signal are to be expected. In the case of a local temperature change, the impedance at the affected point of the measuring body will change. As a result, the previously optimum impedance matching will then be disturbed and reflections, which can then be reliably detected by the receiving unit, will occur for the first time.

The termination resistor can also be a combination of a plurality of passive components such as, for example, an ohmic resistor, a capacitor and/or a diode. Thus, for example, in the case of a termination resistor which has an ohmic resistor and a capacitor connected in series, the ohmic resistance of the insulating material can be measured by applying a DC voltage to the appropriate conductor pair without having to take into account the ohmic resistance of the termination resistor. This enables the ohmic resistance of the insulating material to be measured particularly accurately.

The termination resistor can also have a series circuit comprising (a) an ohmic resistor and (b) a parallel circuit comprising a capacitor and a diode. This enables a polarity-dependent measurement of the resistance of the insulating material to be carried out. If a polarity of the input voltage is chosen with which the diode is connected in the conducting direction, then the capacitor is bypassed apart from the voltage drop which occurs at the diode. If a polarity of the input voltage is chosen with which the diode is connected in the non-conducting direction, then for a direct voltage or direct current measurement the effect of the termination resistor on the resistance measurement of the insulating material can be eliminated in a simple and effective manner.

According to a further exemplary embodiment of the invention, the insulating material is a material whose specific electrical resistance decreases with increasing temperature.

Here, the insulating material can be a synthetic material which displays a so-called NTC (Negative Temperature Coefficient) behavior. At the present time, in particular a thin film composite material with carbon nanoparticle-polyimide (carbon nanoparticle-polyimide composite thin films (BTDA-ODA)), which displays a particularly clear reduction of the specific electrical resistance when the temperature increases, appears to be a suitable material for the insulating material. This material is described, for example, in the publication “MURUGARAJ P., MAINWARING D., MORA-HUERTAS N.: “Thermistor behavior in a semiconducting polymer-nanoparticle composite film”; Journal of physics 2006, vol. 39, no. 10, pp. 2072-2078”.

According to a further exemplary embodiment of the invention, the measuring unit additionally has a resistance measuring unit which is set up to measure the DC resistance between the first electrical conductor and the second electrical conductor and/or between the further first electrical conductor and the further second electrical conductor.

Measuring the DC resistance enables a temperature change which affects the whole measuring body or which affects only a sub-section or sub-region of the measuring body to be easily detected. In the second case, the specific electrical resistance of the insulating material is only changed within the affected sub-section or sub-region. However, this resistance change also contributes to a change in the total resistance between the two electrical conductors due to the parallel connection of many individual insulating resistances between the two electrical conductors described above.

Also, if the location of a local resistance change cannot be determined by this simple measurement of the DC resistance, then the measurement of the DC resistance can be used for a kind of pre-alarm before the exact location of the local temperature change within the measuring body is determined using more elaborate methods.

In this regard, attention is drawn to the fact that, under normal conditions, i.e. at typical room temperatures, a measuring body with the BTDA-ODA insulating material described above has low damping on the one hand and relatively high impedance on the other. If the cable is then heated at a certain point, then the specific resistance of the insulating material reduces at this point. By means of the described resistance measuring unit, a reduction of the total resistance can be determined at the end of the conductor pair concerned and, if necessary, a collective pre-alarm can be triggered for the whole temperature measuring device.

According to a further exemplary embodiment of the invention, the electrical input signal is an electrical pulse.

The electrical pulse can be for example a rectangular pulse with respect to time, which is at least partially reflected at an impedance junction, i.e. at the point of a local impedance change from a high-resistance insulating section to a low-resistance insulating section or vice versa. The local distance from the measuring unit to the point of the measuring body which has a local temperature increase can be determined by measuring the elapsed time between the pulse which is transmitted as an input signal and a reflected pulse which is detected as a response signal by the receiving unit.

The position of the section of the respective conductor pair with a changed specific electrical resistance of the insulating material can therefore be determined by the reflection behavior of electrical waves. In doing so, resort can be made to the basic principles of established conducted radar technology, which is also referred to as Time Domain Reflectometry, TDR.

The reflection factor r of a pulse fed into the cable can be calculated according to line theory from the following equation (1)

r=(R−Zw)/(R+Zw) (1)

Here, R is the electrical resistance of the insulating material at the position of the fault and Zw is the wave resistance of the unaffected measuring body measured at the appropriate conductor pair.

If, in the case of an insulating material with an NTC behavior, the resistance R at the position of the fault now reduces as a result of an increased temperature, then a voltage pulse with a negative sign will migrate back in the direction of the measuring unit. When an insulating material with a PTC (Positive Temperature Coefficient) behavior is used, this will result in a pulse with a positive sign being propagated back in the event of a local increase in temperature.

According to a further exemplary embodiment of the invention, the electrical input signal has a plurality of periodic and in particular sinusoidal individual signals which have different frequencies from one another.

In this case, the different periodic individual signals can be injected sequentially into the measuring body, and the phase shift of the individual response signals which are reflected back at an impedance junction can be measured in each case. The distance from the measuring unit to the point of the measuring body which has a local increase in temperature can likewise be determined in accordance with the basic principles of established Frequency Domain Reflectometry, FDR, from the phase shifts, which have been determined for different frequencies, of the respective individual response signal in relation to the respective individual signal injected into the measuring body.

According to a further exemplary embodiment of the invention, the measuring body is a cable. The use of a cable, which can have one or more conductor pairs, has the advantage that, by simply laying the cable along a linear monitoring region, a spatially resolved temperature measurement can be carried out inside this monitoring region.

According to a further exemplary embodiment of the invention, the cable is a coaxial cable. This means that the insulating material is located between an inner conductor and the outer conductor, which is arranged cylindrically symmetrically with respect to the inner conductor. At the same time, the transmission characteristics of the cable can be optimized in an advantageous manner by the geometrical form and, in particular, by the ratio of the radii of the inner conductor and the outer conductor. The design of the cable in the form of a coaxial cable can however lead to the action of heat on the temperature-sensitive insulating material being somewhat delayed by the outer conductor. As a result, the overall linear temperature measuring device has a somewhat higher thermal inertia.

According to a further exemplary embodiment of the invention, the cable has two strip conductors running adjacent to one another.

At the same time, the two strip conductors can be arranged essentially parallel to one another along the entire length of the cable. A twisted arrangement between the two strip conductors is also possible. The decisive factor is only that, with regard to its specific conductivity, temperature-dependent insulating material is located between the two strip conductors.

The strip conductor can be fitted or arranged in a region to be monitored in such a way that the heat radiation produced by a heat source acts directly on the temperature-sensitive insulating material. This enables a particularly fast response of the linear temperature measuring device to be achieved.

According to a further exemplary embodiment of the invention, the cable additionally has an outer layer.

The outer layer can be a mechanical protective layer which protects the possibly sensitive cable against mechanical damage. The outer layer can, however, also be an additional insulating layer which guarantees a reliable electrical insulation of the cable with respect to other electrical conductors.

According to a further exemplary embodiment of the invention, the outer layer has a material which has at least one predefined heat absorption when exposed to heat radiation.

The outer layer can have a black color, for example, which, in the event of heat radiation caused by a heat source, exhibits a rapid and significant temperature increase of the insulating material, the electrical conductivity of which is temperature-dependent. This enables local temperature changes in the monitored detection region to be detected not only rapidly but also with a high measuring accuracy.

According to a further aspect of the invention, an alarm system for detecting local temperature changes inside a spatial detection region is described. The alarm system is particularly suitable for the spatially resolved detection of fire sources. The alarm system has (a) a central unit and (b) at least one device of the type described above for the spatially resolved measurement of the temperature inside a spatial detection region. The device is coupled to the central unit by means of communications connection.

The alarm system described is based on the knowledge that one or more temperature measuring devices of the type described above, which in each case have the capability of detecting temperature changes in a spatially resolved manner, can be connected to a central unit. The central unit can, of course, also be connected to further peripheral units which can be set up to detect other types of hazard, such as the occurrence of smoke, the presence of toxic gases or break-in attempts for example. The central unit can then jointly evaluate different alarm results from the different peripheral units in a suitable manner, and initiate suitable measures for averting the hazards.

The different peripheral units can be coupled to a central unit by means of a wired and/or by means of a wireless communications connection.

According to a further aspect of the invention, a method for the spatially resolved measurement of the temperature inside a spatial detection region is specified. The method has (a) an application of a time-dependent electrical input signal to a measuring body using a transmitting unit of a measuring unit, and (b) a detection of a time-dependent electrical response signal of the measuring body to the input signal using a receiving unit of the measuring unit. The measuring body has a first electrical conductor, a second electrical conductor and an insulating material which extends between the two electrical conductors and which has a temperature-dependent specific electrical resistance. The measuring unit is connected to the first electrical conductor and to the second electrical conductor.

The method described is also based on the knowledge that, in the event of a change in the temperature of the insulating material, the impedance of the measuring body changes due to its deliberately temperature-dependent electrical resistance. As a result, the impedance of the cable changes, at least within a certain region of the measuring body, particularly for a high-frequency input signal. This change in impedance in turn leads to a specific reflection behavior of the measuring body, in particular for a high-frequency input signal and/or for an input signal which changes very rapidly with respect to time. The appropriate reflections are detected by the receiving unit of the measuring unit and can be analyzed by an evaluation unit connected downstream of the receiving unit.

Further advantages and characteristics of the present invention can be seen from the following exemplary description of currently preferred embodiments. The individual figures of the drawing of this application are to be looked upon as being purely schematic and not true to scale.

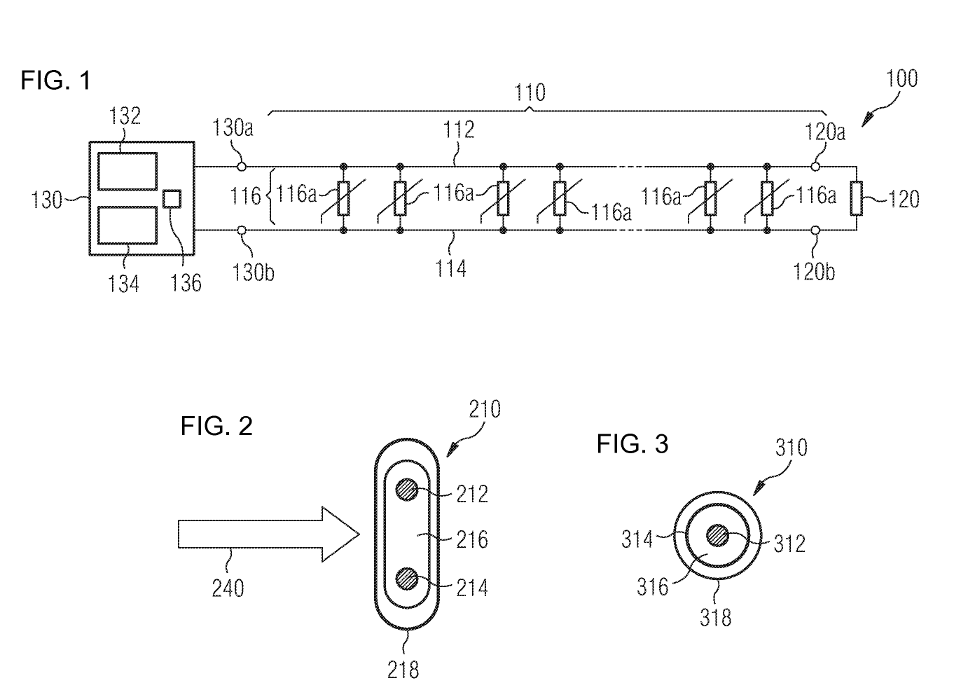

FIG. 1 shows an equivalent circuit of a linear temperature measuring device.

FIG. 2 shows in a cross-sectional view a strip cable with an insulating material which is a synthetic material with an NTC behavior.

FIG. 3 shows in a cross-sectional view a coaxial cable with an insulating material which is a synthetic material with an NTC behavior.

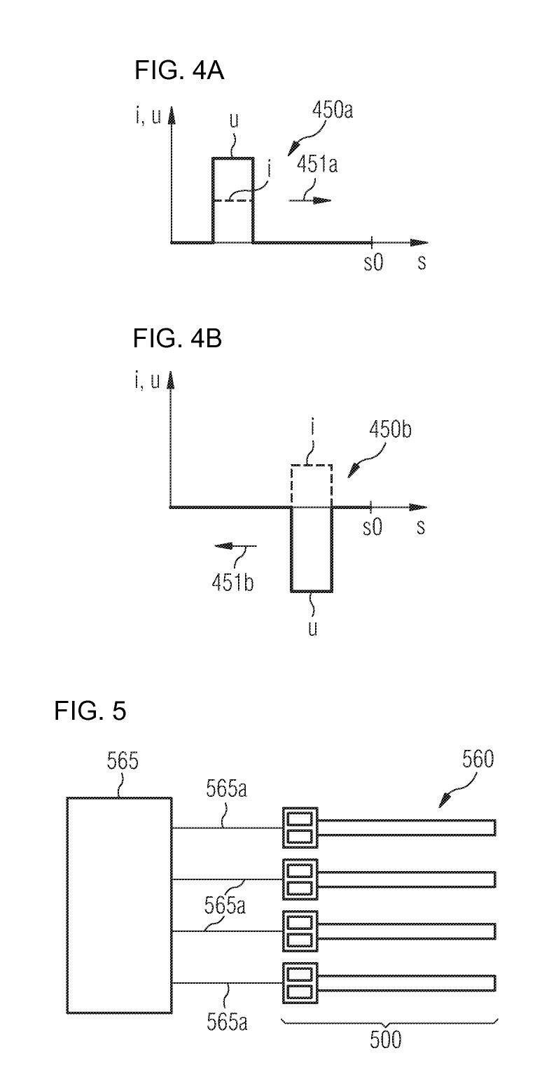

FIG. 4a shows an input pulse which propagates within a cable along a propagation distance s in the positive direction.

FIG. 4b shows an output pulse which results from an at least partial reflection of the input pulse and which propagates within the cable along the propagation distance s in the negative direction.

FIG. 5 shows an alarm system which has a central unit and a total of four linear temperature measuring devices which are connected to the central unit by means of a signal cable in each case.

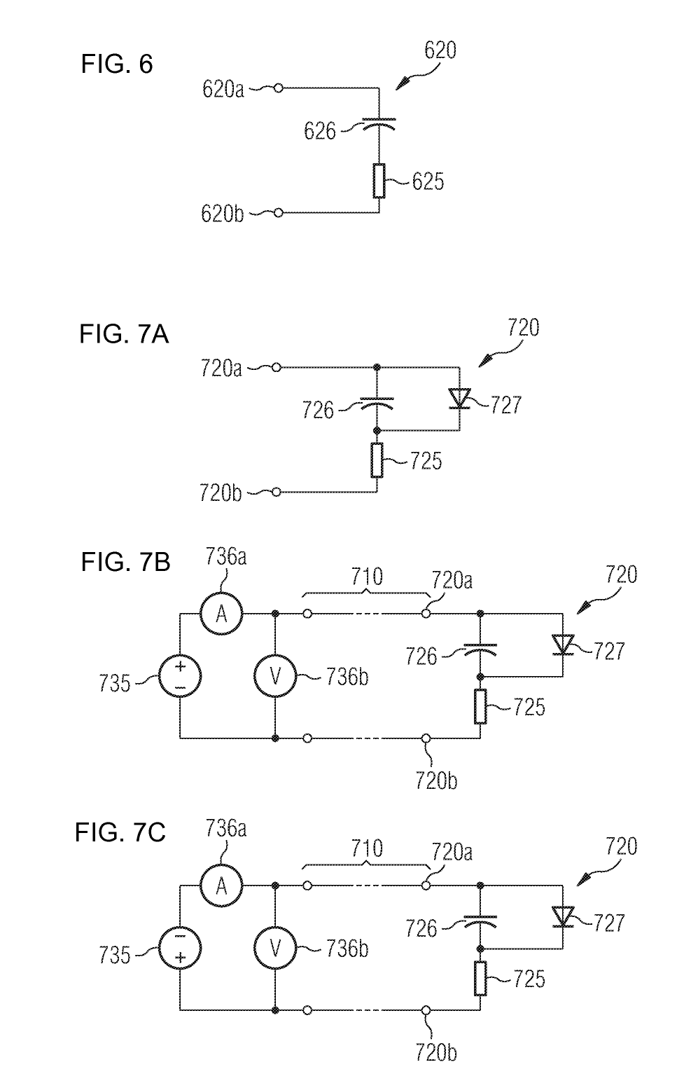

FIG. 6 shows a termination resistor which has a series circuit comprising an ohmic resistor and a capacitor.

FIG. 7a shows a termination resistor which has a series circuit comprising an ohmic resistor and a parallel circuit comprising a capacitor and a diode.

FIG. 7b shows a resistance measurement of the temperature-dependent insulating material carried out under DC conditions using the termination resistor shown in FIG. 7a with a first polarity.

FIG. 7c shows a resistance measurement of the temperature-dependent insulating material carried out under DC conditions using the termination resistor shown in FIG. 7a with a second polarity.

At this point, it remains to note that, in the drawing, the references of identical or corresponding components differ only in their first digit.

FIG. 1 shows a linear temperature measuring device 100 according to an exemplary embodiment of the invention. The temperature measuring device 100 has an electrical cable 110 which serves as a temperature sensor and can be arranged inside a linear detection region. Attention is drawn to the fact that the linear detection region does not necessarily have to run in a straight line. The linear detection region can also be curved and, for example, run around corners and/or edges.

The cable 110 has a first electrical conductor 112 and a second electrical conductor 114. An insulating material 116, which has a temperature-dependent specific electrical resistance, is located between the two conductors 112 and 114.

According to the exemplary embodiment shown here, the insulating material 116 is a synthetic material which has a Negative Temperature Coefficient (NTC) behavior. This means that the specific electrical resistance of the insulating material 116 reduces when the temperature increases.

In FIG. 1 the specific electrical resistance of the insulating material 116 is shown in the form of an equivalent circuit by a plurality of discrete electrical resistors 116a. In reality, the effective resistance between the two conductors 112 and 114 is continuously distributed over the whole length of the cable 110.

The linear temperature measuring device 100 described is based on the physical effect that the wave resistance or impedance of the cable 110 depends not only on the spatial arrangement of the two conductors 112 and 114, but also on the specific resistance of the insulating material 116. If a sub-section of the cable 110 has a changed temperature in comparison with the rest of the cable 110, then the wave resistance within this sub-section is different from the wave resistance of the rest of the cable 110. This means that there is a change in the impedance within the cable 110. This change in impedance then leads to a high-frequency signal, which would otherwise propagate in the cable 110 extensively without interference, being at least partially reflected at the point at which the impedance changes.

Furthermore, in order to measure the reflection behavior of the cable 110, the linear temperature measuring device 100 has a measuring unit 130 which is connected at the input side of the cable 110 to the first electrical conductor 112 by means of a connector 130a, and to the second electrical conductor 114 by means of a connector 130b. In addition, a termination resistor 120 is provided which is connected to the cable 110 at an end opposite the input side of the cable 110. Two connectors 120a and 120b are provided for this purpose which connect the termination resistor 120 to the first electrical conductor 112 and to the second electrical conductor 114 respectively.

The termination resistor 120 is sized in such a way that under normal temperature conditions no reflections are caused at the end of the cable 110. Under normal temperature conditions, the whole cable 110 therefore constitutes a linear measuring cable with a uniform impedance in which no reflections or only very weak reflections of a high-frequency signal are to be expected. In the case of a local temperature change, the impedance at the affected point of the cable 110 will change. As a result, the previously optimum impedance matching will then be disturbed and reflections, which can then be reliably detected by the measuring unit 130, will occur for the first time.

The measuring unit 130 has a transmitting unit 132 in order to inject an input signal into the cable 110. The measuring unit 130 has a receiving unit 134 in order to detect reflected output signals. In this case, the transmitting unit 132 and the receiving unit 134 can be separate electronic circuits. Alternatively, these units 132 and 134 can also be realized by means of a single circuit arrangement.

Furthermore, the measuring unit 130 has an evaluation unit, which is not shown in FIG. 1 for reasons of clarity, connected downstream of the receiving unit 134 and if appropriate also of the transmitting unit 132. The reflection signals detected by the receiving unit 134 can be analyzed by means of the evaluation unit with regard to their time delay and/or with regard to their phase shift with respect to the corresponding input signal. This enables the distance between the measuring unit 130 and the point of the cable 110 which has a locally changed impedance in comparison with the rest of the cable to be determined.

As can be seen from FIG. 1, the measuring unit 130 additionally has a resistance measuring unit 136. The resistance measuring unit 136 is set up to measure the DC resistance of the cable 110.

Measuring the DC resistance enables a temperature change which affects at least a sub-section of the cable to be easily detected. Even when the specific electrical resistance of the insulating material is changed within a comparatively short sub-section, then as a result of the parallel connection of many individual insulation resistances between the two electrical conductors 112, 114, which can be seen in the equivalent circuit, the total ohmic resistance between the two electrical conductors 112 and 114 also changes.

The use of a simple ohmic termination resistor has the advantage that the state of the cable 110 can be monitored effectively. If a resistance which is significantly higher than the termination resistor 120 is measured, namely by means of the resistance measuring unit 136 described above, then this indicates a break in the cable 110. If a resistance which is much lower than the termination resistor 120 and, in the case of an NTC cable, is also lower than the expected cable resistance 116 at a specified maximum temperature, is measured by means of the resistance measuring unit 136, then this indicates a short circuit within the cable 110.

Attention is drawn to the fact that the cable defect can likewise be localized with the high-frequency methods of Time Domain Reflectometry, TDR, or Frequency Domain Reflectometry, FDR, described above.

However, as a result of the parallel connection of the plurality of sub-resistors 116a shown in FIG. 1, the smallest of the sub-resistors 116a always dominates on the connectors 130a and 130b at the cable end. The maximum resistance which can be measured at the connectors 130a and 130b is equal to the termination resistor 120. The resistance of the conductors 112 and 114 is ignored in this consideration. This restricts the dynamics of the resistance measurement.

In order to increase the dynamics of the static resistance measurement, the termination resistor 120 can also be replaced by a series circuit comprising an ohmic resistor and a capacitor with a relatively large capacitance. In the case of an alternating voltage with a sufficiently high frequency, only the ohmic resistance is then seen and no change in the pulse response is to be expected. Under DC conditions, the termination resistor is not seen at all at the connectors 130a and 130b, and the range of the measurable resistance is increased accordingly.

Also, if the location of a local resistance change cannot be determined by this simple measurement of the DC resistance, then the measurement of the DC resistance can be used for a kind of pre-alarm before the exact location of the local temperature change is determined using the measuring methods described above and below, particularly with reference to FIGS. 4a and 4b.

FIG. 2 shows in a cross-sectional view a strip cable 210 which can be used as a measuring cable 110 for the linear temperature measuring device 100 shown in FIG. 1. The strip cable 210 has a first electrical conductor 212 and a second electrical conductor 214 which are embedded in an insulating material 216.

According to the exemplary embodiment shown here, the insulating material 216 is a synthetic material with an NTC behavior. However, other materials, for example with a Positive Temperature Coefficient (PTC) behavior, can also be used.

The insulating material 216 is surrounded by a thin outer layer 218. The outer layer 218 can protect the insulating material 216 from mechanical influences. According to the exemplary embodiment shown here, the outer layer 218 has a black color or at least a dark color so that heat radiation 240 impinging on the cable is absorbed well and therefore leads to a significant temperature increase in the insulating material 216 in the affected section of the cable. The absorption of the heat radiation 240 can additionally be improved in that the outer layer has a certain roughness, thus extensively preventing reflections of the heat radiation 240 on smooth surfaces.

FIG. 3 shows in a cross-sectional view a coaxial cable 310 which can likewise be used as a measuring cable 110 for the linear temperature measuring device 100 shown in FIG. 1. The coaxial cable 310 has a first electrical conductor 312 which constitutes the inner conductor of the coaxial cable 310. A second electrical conductor 314 constitutes the outer conductor of the coaxial cable 310. An insulating material 316, which is likewise a synthetic material with an NTC behavior, is located between the inner conductor 312 and the outer conductor 314.

An outer layer 318 surrounds the outer conductor 314. The outer layer 318 also has a black color or at least a dark color so that heat radiation 310 impinging on the coaxial cable is absorbed well and leads to an as significant a temperature increase as possible in the insulating material 316.

The measurement of the location of a local temperature increase by means of an electrical input pulse injected into the cable and the corresponding reflected output pulse which is partially reflected back at a temperature-induced impedance change is explained below with reference to FIGS. 4a and 4b. Here, the time difference between the injection of the input pulse and the reception of the output pulse which is reflected at a local impedance change is measured when calculating the location of the local temperature increase. As the propagation speed of electrical signals in the cable is known, the spatial distance between the local temperature change and the measuring unit can be determined from the measured time difference. In doing so, resort can be made to the basic principles of established conducted radar technology, which is also referred to as Time Domain Reflectometry, TDR.

As can be seen from FIG. 4a, an electrical input pulse 450a propagates within a cable along a propagation distance s in the positive direction of travel 451a. According to the exemplary embodiment shown here, the current i and the voltage u of the input pulse 450a, which is in the form of a rectangular pulse with respect to time, are in phase.

The input pulse 450a is at least partially reflected at a local impedance change at a point s0. In doing so, the reflection factor is given by the above-mentioned equation (1). As a result, an output pulse 450b, which is shown in FIG. 4b, is produced and propagates within the cable along the propagation distance s in the negative direction of travel 451b. According to the exemplary embodiment shown here, the current level i and the voltage level u are in anti-phase. This means that the current i and the voltage u have different signs from one another.

At this point, attention is drawn to the fact that instead of TDR, resort can also be made to the basic principles of Frequency Domain Reflectometry, FDR known per se, for the spatial localization of a local temperature change or impedance change. In doing so, different periodic individual signals are sequentially injected at the input of the cable, and the phase shift of the individual response signals which are reflected back at the point s0 of a local impedance change are measured in each case. The location s0 of the local temperature change can be determined from the phase shifts, which have been determined for different frequencies, of the respective individual response signal in relation to the respective individual signal which is injected into the cable.

FIG. 5 shows an alarm system 560 which has a central unit 565 and a total of four linear temperature measuring devices 500 which are connected to the central unit by means of a signal cable 565a in each case.

According to the exemplary embodiment shown here, only linear temperature measuring devices 500, with which temperature changes can be detected in a spatially resolved manner in each case, are connected to the central unit. However, attention is drawn to the fact that the central unit 565 can, of course, also be connected to further different kinds of peripheral units or alarm units. These different kinds of alarm units can be smoke alarms, gas alarms and/or intrusion alarms for example. The central unit 565 can then jointly evaluate different alarm results from the different peripheral units in a suitable manner, and initiate suitable measures for averting the hazards.

FIG. 6 shows a termination resistor 620 which has a series circuit comprising an ohmic resistor 625 and a capacitor 626. The termination resistor 620 is connected at connectors 620a and 620b to a cable which is not shown in FIG. 6. According to the exemplary embodiment shown here, this cable is identical to the cable 110 in FIG. 1.

The described series connection of the ohmic resistor 625 with the capacitor 626 has the advantage that the dynamics of a resistance measurement can be significantly increased. When the capacitance of the capacitor 626 is sufficiently large, only the ohmic resistor 625 is detected under AC conditions. A change in the pulse response is not to be expected. Under DC conditions, the termination resistor is not seen by the resistance measurement unit 136 shown in FIG. 1, and the range of the measurable resistance is increased accordingly.

FIG. 7a shows a termination resistor 720 which has a series circuit comprising an ohmic resistor 725 and a parallel circuit comprising a capacitor 726 and a diode 727. The termination resistor 720 is connected at connectors 720a and 720b to a cable which is not shown in FIG. 7. According to the exemplary embodiment shown here, this cable is identical to the cable 110 in FIG. 1.

The use of the series circuit shown in FIG. 7a has the advantage that the static resistance measurement at the connectors 720a and 720b can be carried out with two different polarities. Whether or not it is desired to see the termination resistor 720 can therefore be determined by a suitable choice of the polarity. In this way, the advantages of a static resistance measurement under DC conditions described above can be combined with the advantages of a resistance measurement under AC conditions.

FIG. 7b shows a resistance measurement of the temperature-dependent insulating material of the cable 710 under DC conditions using a termination resistor 720 which has a series circuit comprising an ohmic resistor 725 and a parallel circuit comprising a capacitor 726 with a diode 727. FIG. 7b shows the DC resistance measurement with a first polarity of a voltage source 735 in which the termination resistor is statically seen or detected by a current measuring unit 736a and a voltage measuring unit 736b. This is achieved by the diode 727, which is connected in the conducting direction for the first polarity of the voltage source 735. Under AC conditions, the diode 727 is short-circuited by the capacitor 726 and only the ohmic resistor 725 is seen or detected as the termination resistor.

FIG. 7c shows the resistance measurement of the temperature-dependent insulating material of the cable 710 shown in FIG. 7b with a second polarity of the voltage source 735 in which the ohmic resistor 725 is not seen or not detected under DC conditions. If the resistance of the two electrical conductors of the cable 710 are ignored, the resistance measurement under DC conditions shows the pure resistance of the insulating material of the cable 710.

The linear temperature measuring device described with this application has the following advantages:
The linear temperature measuring device described can be installed with normal electrical installation tools. No special tools are required.
Compared with established linear temperature measuring devices with optical fibers in which the optical fibers may not have a bending radius less than a specified value, the electrical cable can be bent considerably more severely. The linear temperature measuring device can therefore also be laid around a corner without any problems.
A functional test can be carried out on completion of installation with the simplest means, such as a simple digital voltmeter for example. In doing so, any breaks and/or short circuit can easily be found.
A collective alarm can be derived by simple resistance measurement even without a TDR or FDR evaluation unit. In doing so, however, typically no location information can be obtained regarding the heat development acting on the cable.
A signal evaluation based on TDR or FDR technology is insensitive with respect to the drift of an internal clock generator in the measuring unit. The evaluation electronics are therefore stable in the long term and insensitive to temperature variations.

Attention is drawn to the fact that the embodiments described here represent only a limited selection of possible embodiments of the invention. It is therefore possible to combine the characteristics of individual embodiments in a suitable manner so that, with the embodiments explicitly shown here, a multitude of different embodiments are to be seen as being obviously disclosed for the person skilled in the art.

1-14. (canceled)

15. A device for a spatially resolved measurement of a temperature inside a spatial detection region, the device comprising:
a measuring body with a first electrical conductor, a second electrical conductor, and an insulating material extending between said first and second electrical conductors, said insulating material having a temperature-dependent specific electrical resistance; and
a measuring unit connected to said first electrical conductor and to said second electrical conductor;
said measuring unit having a transmitting unit configured to apply a time-dependent electrical input signal to said first and second electrical conductors; and
said measuring unit having a receiving unit configured to detect a time-dependent electrical response signal of said measuring body to the input signal.

16. The device according to claim 15, wherein said measuring body further comprises:
at least one further first electrical conductor;
at least one further second electrical conductor; and
at least one further insulating material extending between said further first and further second electrical conductors, said further insulating material having a temperature-dependent specific electrical resistance.

17. The device according to claim 15, which further comprises a termination resistor connected to said first and second electrical conductors at an end thereof opposite from said measuring unit.

18. The device according to claim 15, wherein said insulating material is a material with a specific electrical resistance that decreases with increasing temperature.

19. The device according to claim 15, wherein said measuring unit further comprises a resistance measuring unit configured to measure a DC resistance between said first electrical conductor and said second electrical conductor.

20. The device according to claim 16, wherein said measuring unit further comprises a resistance measuring unit configured to measure a DC resistance between said first electrical conductor and said second electrical conductor and/or between said further first electrical conductor and said further second electrical conductor.

21. The device according to claim 15, wherein the electrical input signal is an electrical pulse.

22. The device according to claim 15, wherein the electrical input signal has a plurality of periodic individual signals with mutually different frequencies.

23. The device according to claim 22, wherein the individual signals are sinusoidal signals.

24. The device according to claim 15, wherein said measuring body is a cable.

25. The device according to claim 24, wherein said cable comprises one or more conductor pairs and the cable is laid out along a linear monitoring region.

26. The device according to claim 24, wherein said cable is a coaxial cable.

27. The device according to claim 24, wherein said cable has two strip conductors running adjacent one another.

28. The device according to claim 24, wherein said cable additionally has an outer layer.

29. The device according to claim 28, wherein said outer layer has a material with a predefined heat absorption when exposed to heat radiation.

30. An alarm system for detecting local temperature changes inside a spatial detection region, the alarm system comprising:
a central unit; and
at least one device according to claim 15; and
a communications connection connecting said at least one device to said central unit.

31. The alarm system according to claim 30 configured for the spatially resolved detection of fire sources.

32. A method for a spatially resolved measurement of a temperature inside a spatial detection region, the method which comprises:
providing a measuring body in a detection region, the measuring body having a first electrical conductor, a second electrical conductor, and an insulating material extending between the first and second electrical conductors and having a temperature-dependent specific electrical resistance;
providing a measuring unit connected to the first electrical conductor and to the second electrical conductor;
applying a time-dependent electrical input signal to the measuring body using a transmitting unit of the measuring unit; and
detecting a time-dependent electrical response signal of the measuring body in response to the input signal using a receiving unit of the measuring unit; and
deducing from the response signal a spatially resolved measurement result for the detection region.
